(19) United States
(12) Patent Application Publication
(10) Pub. No.: US 2009/0172729 A1
(43) Pub. Date: Jul. 2, 2009

(54) METHOD, SYSTEM AND PROGRAM PRODUCT FOR BROADCASTING SERVICES AVAILABLE TO CONSUMERS AT A LOCATION WHEN RELEVANT

(75) Inventors: Anita J. Bateman, Austin, TX (US); Hung T. Dinh, Austin, TX (US); David P. Lee, Round Rock, TX (US)

Correspondence Address: SILVY ANNA MURPHY, 100 TURNBERRY LANE, CARY, NC, 27518, US

(73) Assignee: INTERNATIONAL BUSINESS MACHINES CORPORATION, Armonk, NY (US)

(21) Appl. No.: 11/968,394

(22) Filed: Jan. 2, 2008

(51) Int. Cl. H04N 7/10

(52) U.S. Cl. 725/34

(57) ABSTRACT

A method, system and program product for automatically broadcasting services available at a location within a broadcast area. The method includes inputting, into a tool configured to broadcast, services available at different locations from multiple service providers and broadcasting in a broadcast area covering the different locations the services available from the multiple service providers. The method further includes delivering broadcasts of services available to a consumer at a location within the broadcast area at a point-in-time, the consumer having a device configured to send a respective location of the consumer to the tool and configured to receive delivery of the broadcasts of the services available at the respective location while the consumer is at the respective location, such that, the broadcasts of the services available alerts the consumer of the services available at the respective location at the point-in-time.

### FIELD OF THE INVENTION

The present invention relates to computer systems and software, and more specifically to an automated technique for delivering broadcasts of services available at a location directly to a consumer, while the consumer is at that location.

### BACKGROUND OF THE INVENTION

Consumers are overloaded with information today—whether it comes from television advertisements, radio, e-mail spam, cell phones, etc. Consumers do not have an easy way to identify and subscribe to available services. With direct marketing (television advertisements, radio), consumers do not have the ability to choose what information to receive and what information to not receive. Accordingly, given the large volumes of advertisements received by consumers, the advertisements are often ignored by consumers. As such, businesses require innovative ways to market themselves and advertise their goods and services and their company as a whole to consumers in a manner that is effective.

### SUMMARY OF THE INVENTION

The present invention resides in a method, system and program product for automatically broadcasting services available at a location within a broadcast area. The method includes inputting, into a tool configured to broadcast, one or more services available at one or more locations from a plurality of service providers and broadcasting in a broadcast area covering the one or more locations the one or more services available from the plurality of service providers. The method further includes delivering broadcasts of the one or more services available to at least one consumer of a plurality of consumers at a location within the broadcast area at a point-in-time, the consumer having a device configured to send a respective location of the consumer to the tool and configured to receive delivery of the broadcasts of the one or more services available at the respective location while the consumer is at the respective location, such that, the broadcasts of the one or more services available alerts the consumer of the one or more services available at the respective location at the point-in-time. In an embodiment, the method further includes storing, in a first repository, service data pertaining to the one or more services available from the plurality of service providers for providing the broadcasts to the plurality of consumers at the one or more locations within the broadcast area. In an embodiment, the method further includes paying, by a respective service provider of the one or more service providers, a fee to a broadcast provider for broadcasting the one or more services available in a respective broadcast area. Further, the method includes detecting when a new service is available within the broadcast area and retrieving data from the repository for broadcasting the new service to the plurality of consumers within the broadcast area. In an embodiment, the broadcasting step further includes broadcasting in one or more broadcast areas covering the one or more locations the one or more services available from the plurality of service providers, the one or more broadcast areas having one or more areas of overlap, such that, the consumer may receive delivery of broadcasts for the one or more services available from the one or more broadcast areas when at a location covered by the one or more broadcast areas. In an embodiment, the delivering step further includes determining whether the consumer at the location within the broadcast area is interested in receiving delivery of broadcasts of the one or more services available at the location and, if the consumer at the location is interested in receiving delivery of broadcasts of the one or more services available at the location, configuring the device for receiving delivery of the broadcasts of the one or more services available at the location within the broadcast area. Further, in an embodiment, wherein the storing step further includes storing, in a second repository, one or more profiles for the respective consumer with respect to broadcasts delivered to the respective consumer over a period of time. Furthermore, the method includes updating the service data stored in the first repository pertaining to the one or more services available from the plurality of service providers within the broadcast area covering the one or more locations and updating the consumer data stored in the second repository pertaining to the one or more profiles for the respective consumer with respect to broadcasts delivered to the respective consumer over a period of time.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart outlining the method steps for automatically delivering broadcasts to a consumer at a location within a broadcast area regarding services available at the location from one or more service providers while the consumer is at the location, in accordance with an embodiment of the present invention.

FIG. 2 is a schematic block system diagram illustrating an embodiment of a system for automatically delivering broadcasts to a consumer at a location within a broadcast area regarding services available at the location from one or more service providers while the consumer is at the location, in accordance with an embodiment of the present invention.

FIG. 3 is a schematic block system diagram illustrating an embodiment of a computer system having deployed thereon a tool for automatically delivering broadcasts to a consumer at a location within a broadcast area regarding services available at the location from one or more service providers while the consumer is at the location, in accordance with an embodiment of the present invention.

FIG. 4 is a schematic illustration of an example of delivering broadcasts to one or more consumers at different locations within a broadcast area, in accordance with an embodiment of the present invention.

FIG. 5 is a schematic block system diagram of a broadcasting infrastructure for delivering broadcasts of services available to consumers while the consumers are at different locations within a broadcast area, in accordance with an embodiment of the present invention.

FIG. 6 is a schematic block system diagram of a broadcasting infrastructure having a service broadcasting tool deployed thereon for delivering broadcasts of services available to consumers while the consumers are at different locations within a broadcast area, in accordance with an embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network. Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

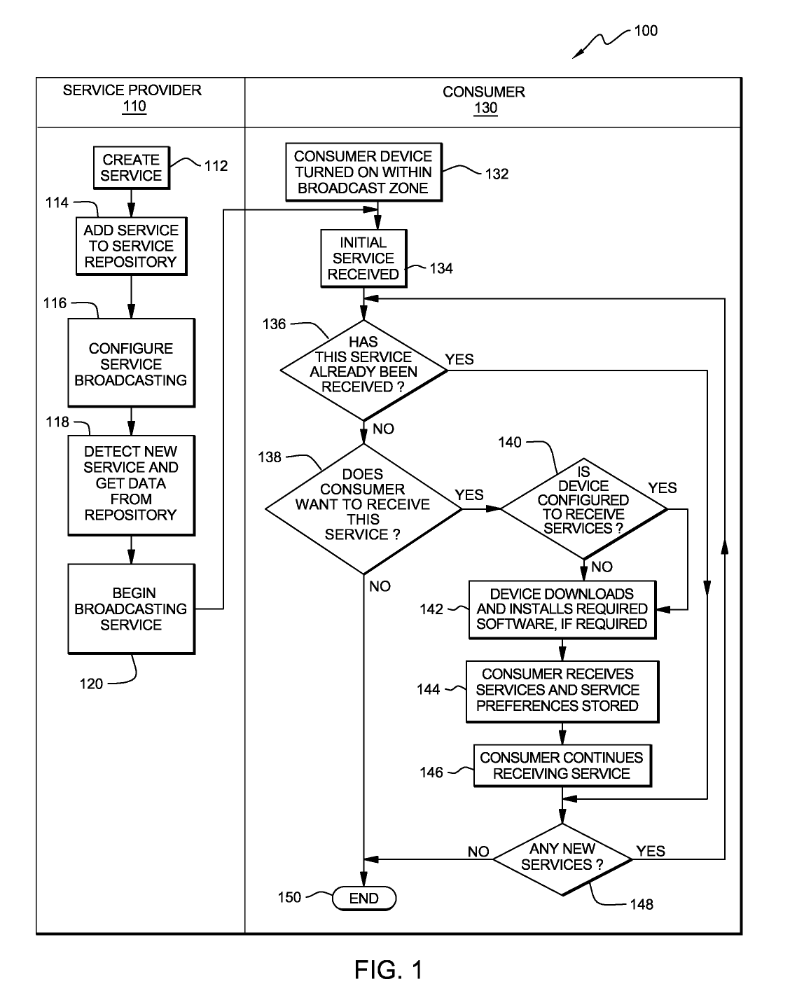

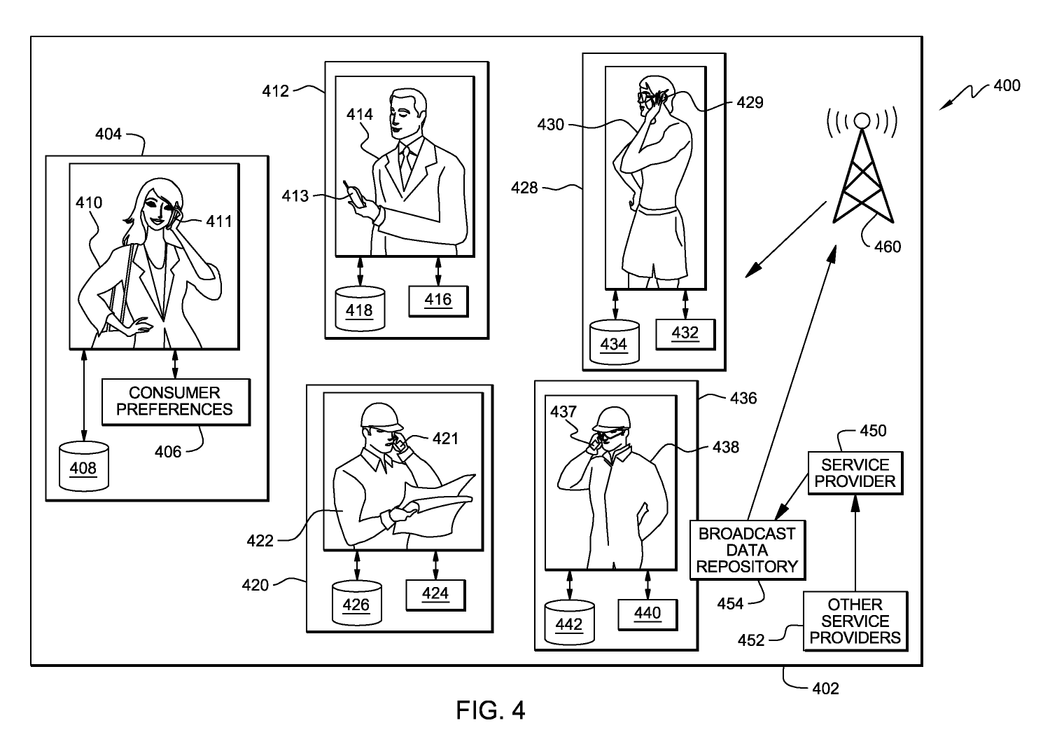

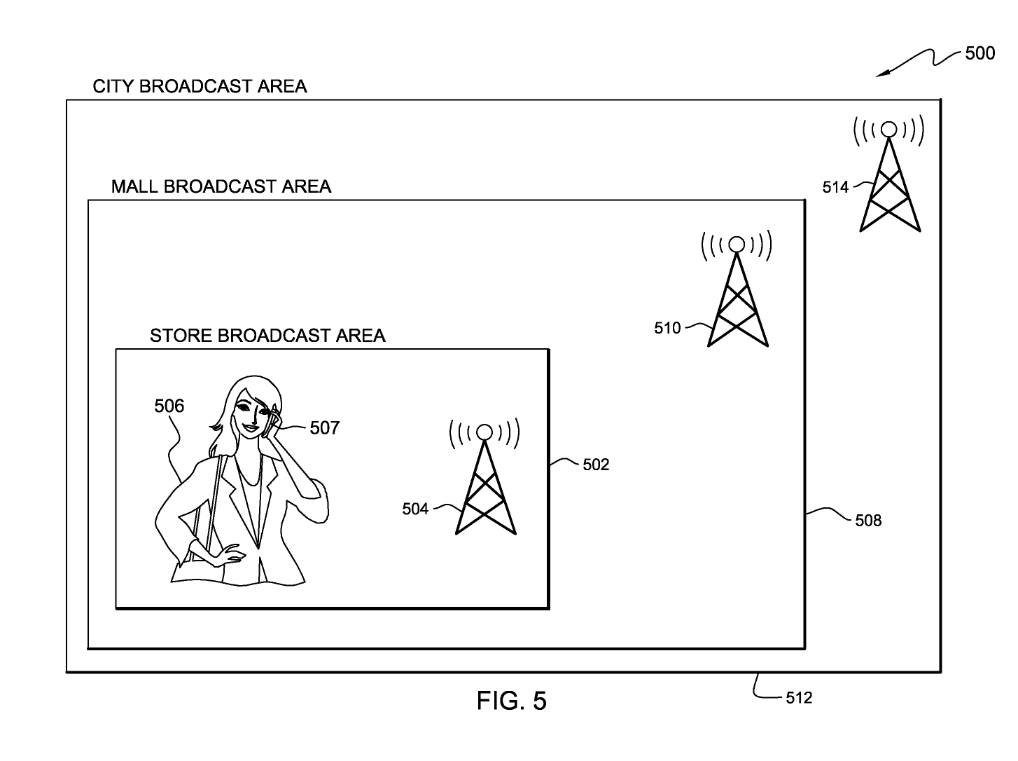

In one embodiment, as shown in FIG. 1, the invention provides a method 100 for automatically broadcasting, using a service broadcasting tool, services available at a location within a broadcast area or broadcast zone, such that, a customer or consumer receives information concerning the services available at the location, while the customer/consumer is at the location. The method begins at step 112, with the service broadcasting tool creating a service in step 112 that is offered by a service provider 110. The service broadcasting tool adds the service to a service repository in step 114. In step 116, the service broadcasting tool configures the service to be broadcasted. Based on the service provider's input and specifications, the broadcasting tool configures whether the service is available at one or more locations and whether the one or more locations are covered by one or more broadcast areas or zones, discussed further herein below with respect to FIGS. 4 and 5. Further, in step 118, the service broadcasting tool determines whether or not the service created is a new service for the service provider and, if so, the service broadcasting tool obtains, in step 118, data from a data repository pertaining to the service provider and any other data that is necessary for broadcasting the service. In step 120, the service broadcasting tool begins broadcasting of the service provided by the service provider 110, as configured in steps 116 and 118. On the other end, a consumer or customer that has a device that is turned on within a broadcast area or zone, receives the initial broadcast of the services available in step 134. The service broadcasting tool determines in step 136 whether or not the service has already been received by the client device. If the service broadcasting tool determines that the service has already been received by the client device, then the service broadcasting tool checks to see in step 148 whether or not any new services have been added by the service provider. If the service broadcasting tool determines from step 148 that no new services have been added or created, then the process ends at step 140. However, if the service broadcasting tool determines in step 148 that new services have been added, then in step 136, the service broadcasting tool determines whether or not the new service has already been received by the client device. In step 136, if the new service has not been received previously by a client device, then in step 138, the service broadcasting tool determines whether or not the consumer of the client device wants to receive broadcasts of the service. If the service broadcasting tool, in step 138, determines that the consumer does not want to receive broadcasts of the service, then the process ends at step 150. However, if the service broadcasting tool determines in step 138 that the consumer does want to receive broadcasts of the service, then in step 140, the service broadcasting tool determines whether or not the client device is configured to receive broadcasts of services. If the service broadcasting tool determines in step 140 that the client device is not configured to receive broadcasts of services, then, the process ends at step 150. However, if the service broadcasting tool determines in step 140 that the client device is configured to receive broadcasts of services, then in step 142, the client device is prompted by the service broadcasting tool to download and install any required software on the client device. Once the required software is installed onto the client device, the consumer can receive broadcasts of the service in step 144. However, if in step 140, the service broadcasting tool determines that the client device is configured to receive broadcasts of services, then in step 144, the consumer receives broadcasts of the services on the client device and, in an embodiment, the service preferences of the consumer are stored by the service broadcasting tool in a storage or repository on the client device itself. The consumer continues receiving broadcasts of the service in step 146. Further, the service broadcasting tool checks periodically in step 148 whether or not new services are available for broadcast. If new services are available for broadcasting to the client device, then the process continues with step 136. However, if new services are not available for broadcasting to a client device, then the process ends at step 140.

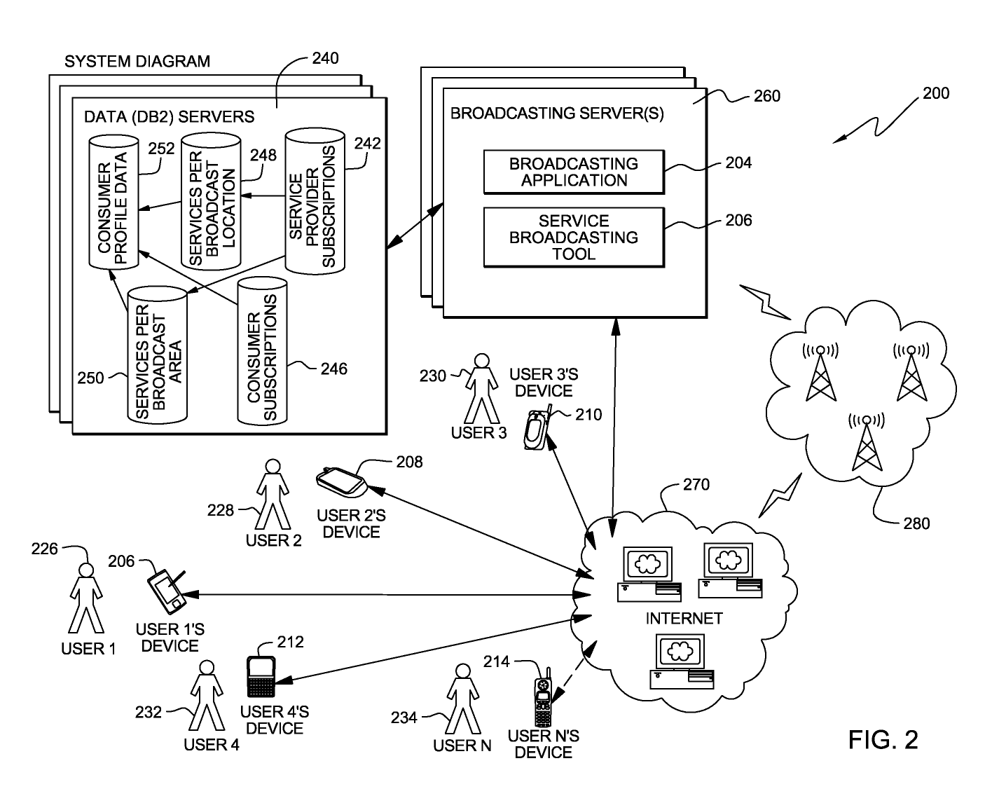

In another embodiment, the invention provides a system for automatically broadcasting services available at a location, such as, a specific store within a broadcast area, such as, a city. In particular, the broadcasts are delivered to a consumer at the store, such that, the customer receives information concerning the services available at the store, while the customer is at the store in the city. Turning to FIG. 2, reference numeral 200 depicts a schematic block system diagram illustrating one embodiment of a computer system 200, such as, a broadcast system 200 that is configured to automatically broadcasts services available at a given location within a broadcast area or zone to consumers within the broadcast area. In an embodiment, a broadcast system 200 covers a broadcast area, that is, an area covered by a signal broadcasted by a broadcasting sub-system, such as, broadcasting sub-system 280, for providing consumers relevant information pertaining to services available at a given location while the consumer is at the given location. In an embodiment, the system 200 comprises at least one server 260 that has deployed thereon a broadcasting application 204 and a service broadcasting tool or code 206 configured to automatically deliver broadcasts of services available in a given location to one or more consumers. As shown in FIG. 2, in an embodiment, the system 200 includes a plurality of servers 260 and a plurality of broadcasting sub-systems 280 that are configured to broadcast to different locations within different broadcast areas or zones. In an embodiment, the broadcasting servers 260 are coupled to the plurality of broadcasting sub-systems 280. Further, in an embodiment, the broadcasting sub-system 280 comprises of one or more broadcast towers having antennas for broadcasting services available to one or more consumers or customers directly, that is, to broadcast services directly to one or more client devices belonging to consumers. Further, the system 200 includes a network communications channel 270, such as, the Internet, which enables a broadcast provider to broadcasts services provided via the broadcasting servers 260 on client devices used by consumers, where the client devices as well as the broadcasting servers 260 are connected to the network communications channel 270, which facilitates broadcasting of the services available from one or more service providers within one or more locations covered by one or more broadcast areas or zones. For instance, a user 1 (reference numeral 226) using a client 206 may receive broadcasts of the services available and broadcasted via the broadcasting sub-system 280 and the network communications channel 270. Similarly, users 2, 3, 4 through N (reference numerals 228, 230, 232 through 234, respectively) may receive broadcasts of the services available and broadcasted via the broadcasting sub-system 280 and the network communications channel 270. In an embodiment, data associated with broadcasting services available from one or more service providers in one or more locations in one or more broadcast areas is stored in one or more database servers 240. As shown in FIG. 2, in an embodiment, the service broadcasting tool 206 maintains subscription data for the one or more service providers providing services to be broadcasted in a database 242. Further, the service broadcasting tool 206 stores subscription data pertaining to the one or more consumers wanting to obtain broadcasts of the services available at given locations within certain broadcast areas in database 246. Further yet, the service broadcasting tool 206 stores data pertaining to services provided by a service provider in a location, such as, a store, or a museum or a library, etc. in database 248. In addition, the service broadcasting tool 206 stores data pertaining to services provided by a service provider within one or more locations within a broadcast area or zone, such as, stores within a mall or certain stores within a city, etc. in database 250. Further, the service broadcasting tool 206 stores consumer profiles with respect to one or more services selected, over a period of time, from the services available from various service providers in a location within a broadcast area in database 252.

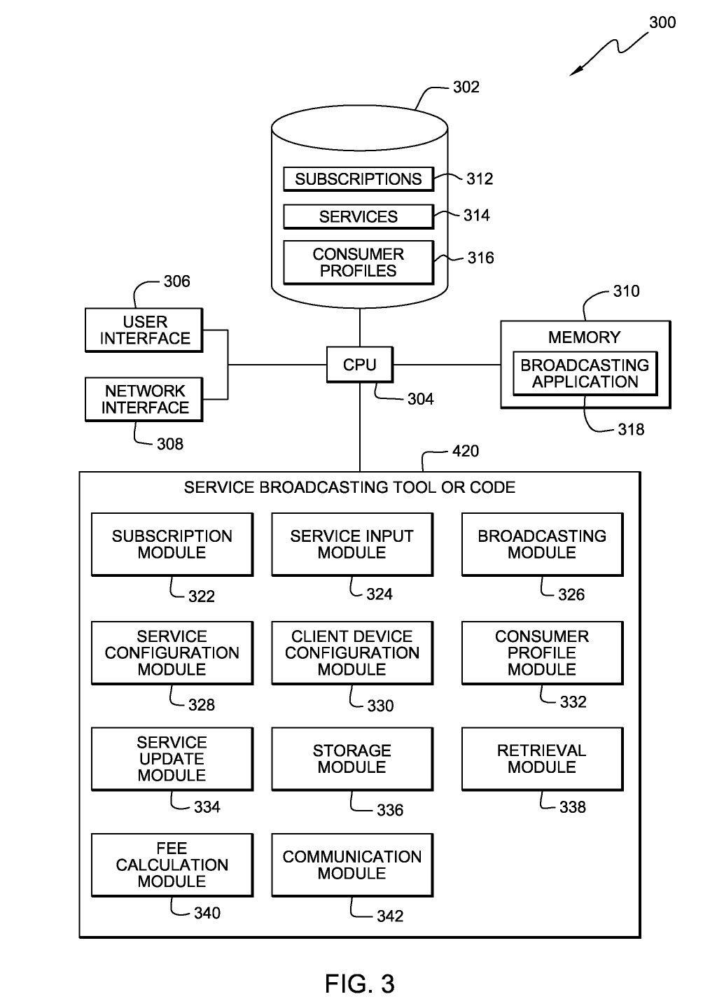

Reference is now made to FIG. 3, reference numeral 300, which depicts a schematic block system diagram illustrating one embodiment of a computer system 300, such as, a server that has deployed thereon or is coupled to a system that has deployed thereon a service broadcasting tool or code 320 that is configured to automatically broadcasting services available at a location within a broadcast area to a consumer at the location, such that, the customer receives information concerning the services available at the location, while the customer is at the location within the broadcast area. As shown in FIG. 3, the server or system 300 comprises a central processing unit (CPU) 304, a local storage device 302, a user interface 306, a network interface 308 and a memory 310. The CPU 304 is configured generally to execute operations within the system/server 300, such as, the broadcasting application 318 and the service broadcasting tool or code 320 stored in memory 310. The network interface 306 is configured, in one embodiment, to facilitate network communications of the system 300 over a communications channel of a network. In one embodiment, as shown in FIG. 3, the service broadcasting tool 320 comprises a logic unit that contains a plurality of modules configured to functionally execute the necessary steps for automatically broadcasting services available at a location within a broadcast area to a consumer at the location, such that, the customer receives information concerning the services available at the location, while the customer is at the location within the broadcast area. In particular, the service broadcasting tool or code 320 comprises a subscription module 322, a service input module 324, a broadcasting module 326, a service configuration module 328, a client device configuration module 330, a consumer profile module 332, a service update module 334, a storage module 336, a retrieval module 338, a fee calculation module 340 and a communications module 342.

Referring to FIG. 3, the subscription module 322 of the service broadcasting tool 320 maintains or stores data pertaining to subscriptions 312 in a storage system, for instance, storage or database 302 within system 300. In an embodiment, the subscription module 322 stores data pertaining to both service provider subscriptions and client subscription within storage 302. The service input module 324 allows input of services offered by various service providers in different locations covered within a broadcast area. In an embodiment, the services 314 are stored in a storage system, such as, storage 302. The broadcasting module 326 broadcasts services available in a location to consumers at that location. The service configuration module 328 configures the one or more services offered by one or more service providers in one or more locations with a broadcast area and/or within several broadcast areas. The client device configuration module 330 configures the one or more client devices used by consumers in order to deliver broadcasts of the one or more services available at a given location when the consumers are at that given location. In an embodiment, the client device configuration module 330 determines a location of a consumer in a broadcast area and conveys the location information to the service broadcasting tool 320. The consumer profile module 332 stores a consumer profile for each subscribed consumer based on the services that a consumer has subscribed to. In an embodiment, the consumer profiles 316 are stored in storage or repository 302. Further, the service update module 334 updates the one or more services inputted into the service input module 324, such that, updated services available at a location can be broadcasted to consumers. The storage module 336 stores data pertaining to services, service providers, consumers and/or client devices in a storage system, such as, the storage 302. In an embodiment, the storage module 336 stores updated data pertaining to services, service providers, consumers and/or client devices in a storage system, such as, the storage 302. Further, the retrieval module 338 retrieves data from the storage system for broadcasting services available at a location to one or more consumers at the location. The fee calculation module 340 calculates fees to be paid by service providers to a broadcast owner of a broadcast system configured to delivery broadcasts of services available at a location to one or more consumers at the location. Further the fee calculation module 340 calculates a fee to charge a consumer that receives delivery of broadcasts for services available at a location that the customer is at. In an embodiment, the consumer fee is configurable within the service details, to allow both free services to consumers and fee-based services to consumers. The communication module 342 permits communication between the various modules of the service broadcasting tool or code 320 and other systems, such as, the storage 302.

Reference is now made to FIGS. 4 and 5, which together show examples of broadcasting services available to consumers at a location, while the consumers are at the location. Turning to FIG. 4, reference numeral 400 illustrates an example of broadcasting services available to consumers at different locations within a broadcast area serviced by a broadcast provider using a broadcasting sub-system 460. In particular, the services available through service providers 450 and other service providers 452 are stored in a broadcast data repository 454 and are broadcasted directly to a consumer's device, while the consumer is at the location, such that, the consumer receives up-to-date information concerning services that are available at that location. As shown in FIG. 4, a broadcast area 402 may comprise of several locations 404, 412, 420, 428 and 436. For instance, the broadcast area 402 may include an entire city or may include a county, etc. Further, the broadcast area 402 may includes one or more locations, such as, workplaces, stores, vacation spots, etc., anywhere where service providers want to broadcast information pertaining to services that are available to consumers in those locations. Alternatively, a broadcast area 402 may include a smaller area, such as, a mall, which has several stores or locations within the mall, where services are available to consumers. For instance, a consumer 410 at location 404, for instance, a work place, within broadcast area 402, for instance, a city, receives broadcasts of services that are available at the workplace 404 directly to their device 411, which is configured to receive the broadcasts, as described herein with respect to FIG. 1. Further, the consumer's selection or preferences with respect to receiving services are stored as consumer preferences 406 within the client device itself, whereas, consumer data with respect to services that are provided to consumers over a period of time are stored by the service broadcasting tool as consumer profiles in a customer repository or database 408. Similarly, a consumer 414 at a location 412, such as, a hotel, receives broadcasts of services that are available at the hotel 412 directly to their device 413, which is configured to receive the broadcasts. The consumer's selection or preferences with respect to receiving services are stored as consumer preferences 416 within the client device itself, whereas, consumer data with respect to services that are provided to consumers over a period of time are stored by the service broadcasting tool as consumer profiles in a customer repository or database 418. Furthermore, a consumer 422 at a location 420, such as, a work site, receives broadcasts of services that are available at the work site 420 directly to their device 421, which is configured to receive the broadcasts. Again, the consumer's selection or preferences with respect to receiving services are stored as consumer preferences 424 within the client device itself, whereas, consumer data with respect to services that are provided to consumers over a period of time are stored by the service broadcasting tool as consumer profiles in a customer repository or database 426. Similarly, a consumer 430 at a location 428, such as, a beach or vacation spot, receives broadcasts of services that are available at the vacation spot or beach 428 directly to their device 429, which is configured to receive the broadcasts. Again, the consumer's selection or preferences with respect to receiving services are stored as consumer preferences 432 within the client device itself, whereas, consumer data with respect to services that are provided to consumers over a period of time are stored by the service broadcasting tool as consumer profiles in a customer repository or database 434. Moreover, another consumer 438 at a location 436, such as, a work site, receives broadcasts of services that are available at the work site 436 directly to their device 437, which is configured to receive the broadcasts. Again, consumer's selection or preferences with respect to receiving services are stored as consumer preferences 440 within the client device itself, whereas, consumer data with respect to services that are provided to consumers over a period of time are stored by the service broadcasting tool as consumer profiles in a customer repository or database 442. Further, referring to FIG. 5, reference numeral 500 shows an example of overlapping broadcast areas. For example, a broadcast provider may provide broadcasts to a device 507 of a consumer 506 that covers a broadcast area 512 comprising an entire city or may provide broadcasts for a broadcast area 510 that comprises a mall area or may provide broadcasts to a broadcast area 502 that comprises a store. As such, a broadcasting sub-system, such as, broadcasting sub-system 504 is also covered by broadcasting sub-systems 510 and 514. Similarly, a broadcasting sub-system, such as, broadcasting sub-system 510 is also covered by broadcasting sub-system 514. Accordingly, in an embodiment, there is an overlap of various broadcasting sub-systems that provide broadcasts to consumers within a broader broadcast area.

As such, the consumer device (that is, a cell phone, PDA, iPod, etc.) may include various languages and/or / settings, such that, consumers can specify what services and information formats they would like to receive through their client device software. Further, the consumer client device software system provides a repository for storing preferences and is configurable to set the consumer's preferences as well as system security, etc. For example, a consumer with a handheld device that is turned on enters a mall where services that are available include general mall services and store-specific services. The consumer receives notification of general mall services on their device, such as, directory services, mall-wide promotions and special events. The consumer selects whether or not to receive specific services and, as the consumer walks through the mall, the consumer's device receives updated or new services from the mall broadcast system. For instance, as the consumer enters a store, the consumer's device receives store-specific service notification on their device, such as store sales and/or specials. Again, the consumer selects whether or not to receive specific services, such that, the consumer only receives services that are of interest to the consumer. Another example would be a consumer going to a museum with a handheld device turned on. The services that are available at the museum may include general museum services, floor-specific services, gallery and/or/room services. Again, the consumer receives on the handheld device notification of general museum services, such as, directory services and gallery services. As the consumer walks through the museum, the consumer receives notification of new services that may be specific to the floor that the consumer is at or the gallery or room that the consumer has entered. The consumer can select whether or not to receive the specific services. For instance, the consumer walks up to a display, the consumer can select to receive notification of services about the display. The services might contain information in a multi-media format that enhances the user experience (i.e. history of a painting, biography of the artist), similar to a guided tour service. Other example usage scenarios include: amusement/theme parks, downtown areas, transportation hubs, corporate office navigation, schools/universities, national/state parks, etc.

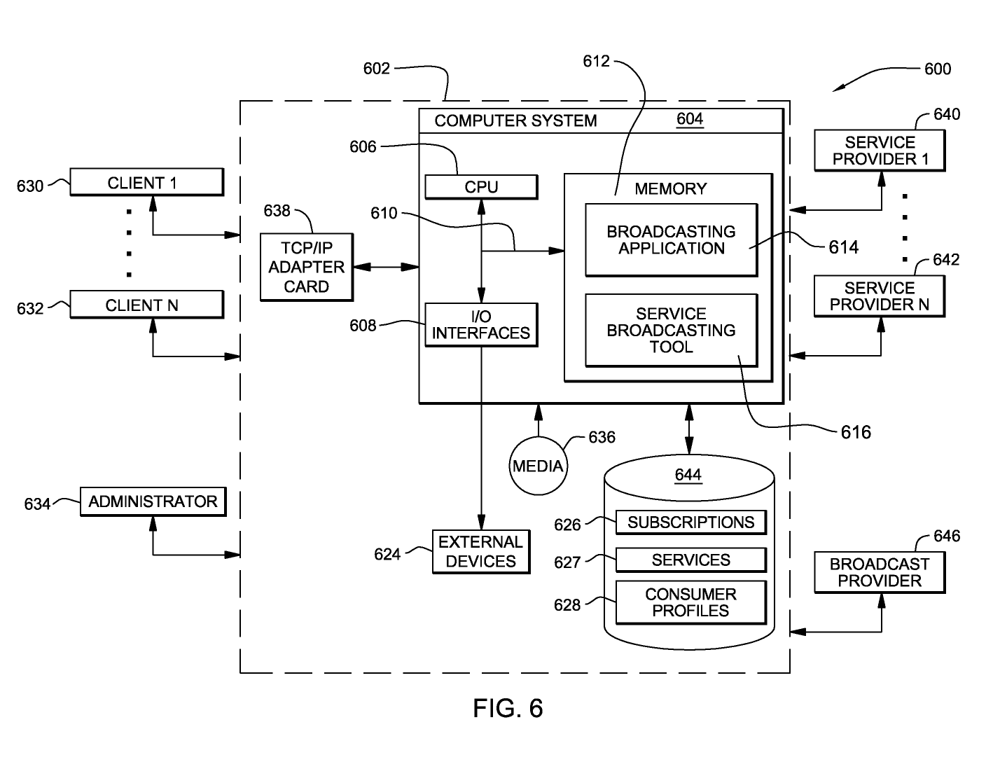

Referring now to FIG. 6, there is illustrated a computer system 600 that includes a computer infrastructure 602 having a computer program product configured to automatically broadcast services available at a location within a broadcast area to a consumer at the location, such that, the customer receives information concerning the services available at the location, while the customer is at the location within the broadcast area, in accordance with an embodiment of the present invention. The computer program product comprises a computer readable or computer-usable medium, which provides program code, such as, the broadcasting application 614 and a service broadcasting tool 616, for use by or in connection with a computer or any instruction execution system. The service broadcasting tool or program 614 can be loaded into computer system 604 from a computer readable media 636, such as, a magnetic tape or disk, optical media, DVD, memory stick, semiconductor memory, etc. or downloaded from the Internet via a TCP/IP adapter card 638. As depicted in FIG. 6, system 600 includes a computer infrastructure 602, which is intended to represent any type of computer architecture that is maintained in a secure environment (i.e., for which access control is enforced). As shown, infrastructure 602 includes a computer system 604 that typically represents a broadcasting server or system 604 or the like that includes a broadcasting application 614 and a service broadcasting tool 616 configured to automatically broadcast services available at a location within a broadcast area to a consumer at the location, such that, the customer receives information concerning the services available at the location, while the customer is at the location within the broadcast area. It should be understood, however, that although not shown, other hardware and software components (e.g., additional computer systems, routers, firewalls, etc.) could be included in infrastructure 602.

In general, a consumer using their respective client 1 (reference numeral 630) through user N (reference numeral 632) may automatically receive delivery of broadcasts regarding services available at locations within a broadcast area, while the consumer is at the location, from the broadcasting system or server 604, which has deployed thereon the broadcasting application 614 and the service broadcasting tool 616, which implements the invention. The service broadcasting tool or program 616 is run on the server 604 to automatically deliver broadcasts of services available at locations within one or more broadcast areas reached by the server 604. In an embodiment, the broadcasting application 614 deployed on server or system 604 is configured to broadcast signals to one or more broadcasting towers and is further configured to invoke the service broadcasting tool 616 for automatically delivering broadcasts of services available at locations within a broadcast area, while the consumer is at the location. It is understood that although the service broadcasting tool 616 is shown as being deployed on the same server as the broadcasting application 614, the service broadcasting tool 616 may be deployed on another server within infrastructure 602. Further, one or more service providers, such as, service provider 1 (reference numeral 640) through service provider N (reference numeral 642) may access system 604 for adding services available in locations within one or more broadcast areas.

As shown in FIG. 6, the broadcasting server or system 604 (which has implemented thereon the service broadcasting tool 616) is shown in communication with a general storage or file system 644, which stores a list of subscriptions 626 for service providers providing services within one or more broadcast areas served by a broadcasting system. Further, storage 644 stores the one or more services available by the one or more service providers in one or more locations within one or more broadcast areas. In addition, the storage 644 stores consumer profiles with respect to services subscribed to by the one or more consumers. In particular, a consumer using a client, such as, client 1, reference numeral 630, is delivered broadcasts by the broadcasting system 604 utilizing broadcast towers to broadcast signals within a broadcast area over a network via interfaces (e.g., web browsers) loaded on a client, for example, a PDA (Personal Digital Assistant), a cell phone or other handheld devices. In an embodiment, the network can be any type of network such as the Internet, a local area network (LAN), a wide area network (WAN), a virtual private network (VPN), etc. In any event, communication with infrastructure 602 could occur via a direct hardwired connection (e.g., serial port), or via an addressable connection that may utilize any combination of wired line and/or wireless transmission methods. Moreover, conventional network connectivity, such as Token Ring, Ethernet, Wi-Fi or other conventional communications standards could be used. Still yet, connectivity could be provided by conventional TCP/IP sockets-based protocol. In this instance, the parties could utilize an Internet service provider to establish connectivity to infrastructure 602. It should be understood that under the present invention, infrastructure 602 could be owned and/or operated by a party, such as, a broadcast provider 646 that provides broadcasting services to service providers 640 through 642, or by an independent entity. Regardless, use of infrastructure 602 and the teachings described herein could be offered to the parties on a subscription or fee-basis. In either scenario, an administrator 634 could support and configure infrastructure 602, for instance, upgrading the service broadcasting tool 616 deployed on the broadcasting server or system 604.

The broadcasting system or server 604 is shown to include a CPU (hereinafter “processing unit 606”), a memory 612, a bus 610, and input/output (I/O) interfaces 608. Further, the server 604 is shown in communication with external I/O devices/resources 624 and storage system 642. In general, processing unit 606 executes computer program code, such as the broadcasting application 614 and the service broadcasting tool 616. While executing computer program code, the processing unit 606 can read and/or write data to/from memory 612, storage system 644, and/or I/O interfaces 608. For instance, in one embodiment, the service broadcasting tool 616 stores subscriptions 626, services 627 and consumer profiles 628 in a working directory in storage 644. Similarly, the service broadcasting tool 616 stores other data, such as, advertisers 626 in storage 644. Alternatively, the data stored in storage 644 may be stored in a separate storage within the system 604. Bus 610 provides a communication link between each of the components in computer system 600, such that information can be communicated within the infrastructure 602. External devices 624 can comprise any devices (e.g., keyboard, pointing device, display, etc.) that enable a consumer to interact with computer system 600 and/or any devices (e.g., network card, modem, etc.) that enable server 604 to communicate with one or more other computing devices.

Computer infrastructure 602 is only illustrative of various types of computer infrastructures for implementing the invention. For example, in an embodiment shown, computer infrastructure 602 comprises two or more computing devices (e.g., a server cluster) that communicate over a network to perform the various process steps of the invention. Moreover, computer system 600 is only representative of various possible computer systems that can include numerous combinations of hardware. To this extent, in other embodiments, computer system 600 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 606 may comprise a single processing unit, or be distributed across one or more processing units in one or more locations, e.g., on a client and server. Similarly, memory 612 and/or storage system 644 can comprise any combination of various types of data storage and/or transmission media that reside at one or more physical locations. Further, I/O interfaces 608 can comprise any system for exchanging information with one or more external devices 624. Still further, it is understood that one or more additional components (e.g., system software, math co-processing unit, etc.) not shown in FIG. 6 can be included in computer system 600. Storage system 644 can be any type of system (e.g., a database) capable of providing storage for information under the present invention, such as the files to be preprocessed by the service broadcasting tool 616. To this extent, storage system 644 could include one or more storage devices, such as a magnetic disk drive or an optical disk drive. In another embodiment, storage system 644 includes data distributed across, for example, a local area network (LAN), wide area network (WAN) or a storage area network (SAN) (not shown). Although not shown, additional components, such as cache memory, communication systems, system software, etc., may be incorporated into computer system 600.

Accordingly, the invention provides the ability to deliver broadcast location based services to a consumer/customer while the consumer is at the location, so that the broadcast reaches the consumer at the most relevant point in time for the consumer to take advantage of the location based services. Further, the invention provides consumers the ability to filter information and receive it in a format they want to receive it in (such as, localized text/video/audio, etc.). Additionally, the invention provides a method for service providers to reach new markets and clients by exposing their services in a consistent manner to many more consumers, without depending on the consumer to initiate the interaction, and by providing providers with a direct line to interested consumers at the most relevant point in time.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for automatically broadcasting services available at a location within a broadcast area, said method comprising the steps of:
inputting, into a tool configured to broadcast, one or more services available at one or more locations from a plurality of service providers;
broadcasting in a broadcast area covering said one or more locations said one or more services available from said plurality of service providers; and
delivering broadcasts of said one or more services available to at least one consumer of a plurality of consumers at a location within said broadcast area at a point-in-time, said at least one consumer having a device configured to send a respective location of said at least one consumer to said tool and configured to receive delivery of said broadcasts of said one or more services available at said respective location while said at least one consumer is at said respective location, wherein said broadcasts of said one or more services available alerts said at least one consumer of said one or more services available at said respective location at said point-in-time.

2. A method according to claim 1, further comprising the step of:
storing, in a first repository, service data pertaining to said one or more services available from said plurality of service providers for providing said broadcasts to said plurality of consumers at said one or more locations within said broadcast area.

3. A method according to claim 2, further comprising the step of:
paying, by a respective service provider of said one or more service providers, a fee to a broadcast provider for broadcasting said one or more services available in a respective broadcast area.

4. A method according to claim 3, further comprising the steps of:
detecting when a new service is available within said broadcast area; and
retrieving data from said repository for broadcasting said new service to said plurality of consumers within said broadcast area.

5. A method according to claim 4, wherein said broadcasting step further comprises the step of:
broadcasting in one or more broadcast areas covering said one or more locations said one or more services available from said plurality of service providers, said one or more broadcast areas having one or more areas of overlap; wherein said at least one consumer may receive delivery of broadcasts for said one or more services available from said one or more broadcast areas when at a location covered by said one or more broadcast areas.

6. A method according to claim 5, wherein said delivering step further comprises the step of:
determining whether said at least one consumer at said location within said broadcast area is interested in receiving delivery of broadcasts of said one or more services available at said location; and
if said at least one consumer at said location is interested in receiving delivery of broadcasts of said one or more services available at said location, configuring said device for receiving delivery of said broadcasts of said one or more services available at said location within said broadcast area.

7. A method according to claim 6, wherein said storing step further comprises the step of:
storing, in a second repository, one or more profiles for said respective consumer with respect to broadcasts delivered to said respective consumer over a period of time.

8. A method according to claim 7, further comprising the steps of:
updating said service data stored in said first repository pertaining to said one or more services available from said plurality of service providers within said broadcast area covering said one or more locations; and
updating said consumer data stored in said second repository pertaining to said one or more profiles for said respective consumer with respect to broadcasts delivered to said respective consumer over a period of time.

9. A system for automatically broadcasting services available in a location, comprising:
a broadcasting sub-system comprising of one or more broadcast towers having one or more antenna, said broadcasting sub-system being configured to broadcast;
a network communications channel;
at least one server coupled to said broadcasting sub-system and said network communications channel, said at least one server having deployed thereon a tool configured to broadcast one or more services available from a plurality of service providers, in a broadcast area covering one or more locations, said tool utilizing said broadcasting sub-system and said network communications channel to broadcast in said broadcast area;
one or more clients coupled to said network communications channel, each of said one or more clients having a user interface configured to send, to said tool, a respective location of a respective consumer of one or more consumers at a given point-in-time and configured to receive broadcasts of said one or more services available at said respective location from said plurality of service providers; wherein said tool further comprises:
a subscription module configured to create an account for a service provider of said one or more service providers interested in broadcasting said one or more services available within said broadcast area;
a service module configured to receive input pertaining to said one or more services available from said one or more service providers at said one or more locations within said broadcast area;
a broadcasting module configured to broadcast said one or more services available at said one or more locations in said broadcast area;
a service configuration module configured to configure a service available from said one or more service providers within said broadcast area; and
a client device configuration module configured to configure a client device of a consumer to send said respective location of said respective consumer and to receive said broadcasts of said one or more services available at said respective location from said one or more service providers; and

10. The system according to claim 9, wherein said tool further comprises:
a consumer profile module configured to maintain a profile for said respective consumer with respect to broadcasts delivered to said respective consumer over a period of time.

11. The system according to claim 10, wherein said tool further comprises:
an update module configured to update said one or more services available from said one or more service providers within said broadcast area covering said one or more locations.

12. The system according to claim 11, wherein said tool further comprises:
a fee calculation module configured to calculate a fee to be paid by said one or more service providers to a broadcast provider for broadcasting said one or more services available within said one or more locations.

13. The system according to claim 12, wherein said tool further comprises:
a fee calculation module configured to calculate a fee to be paid by said one or more consumers for receiving said broadcasts of said one or more services available within said one or more locations.

14. The system according to claim 13, wherein said tool further comprises:
a storage and retrieval module configured to store data pertaining to said one or more services available from said one or more service providers and configured to retrieve said data pertaining to said one or more services available for said respective consumer of said one or more consumers at said respective location.

15. A computer program product for automatically broadcasting services available in a location, said computer program product comprising:
a computer readable medium;
first program instructions to input data pertaining to one or more services available at one or more locations from a plurality of service providers;
second program instructions to broadcast in one or more broadcast areas covering said one or more locations said one or more services available from said plurality of service providers, said second program instructions including instructions to receive payment from a respective service provider of said one or more service providers for broadcasting said one or more services available at said one or more locations;
third program instructions to deliver broadcasts of said one or more services available to a device of at least one consumer of a plurality of consumers at a location within said broadcast area at a point-in-time while said at least one consumer is at said location, said device being configured to send a respective location of said at least one consumer at said point-in-time, and wherein said first, second and third program instructions are recorded on said computer readable medium.

16. The computer program product according to claim 15, further comprising:
fourth program instructions to store in a first repository service data pertaining to said one or more services available from said plurality of service providers for providing said broadcasts to said plurality of consumers at said one or more locations within said broadcast area, to store in a second repository consumer data pertaining to consumer profiles for said and plurality of consumers with respect to broadcasts delivered to said plurality of consumers over a period of time, and wherein said fourth program instructions are recorded on said computer readable medium.

17. The computer program product according to claim 16, wherein said first program instructions include instructions to update said service data stored in said first repository pertaining to said one or more services available from said plurality of service providers within said broadcast area covering said one or more locations and to update said consumer data stored in said second repository pertaining to said consumer profiles for said and plurality of consumers with respect to broadcasts delivered to said plurality of consumers over a period of time, respectively.

18. The computer program product according to claim 17, wherein said second program instructions include instructions to broadcast in one or more broadcast areas covering said one or more locations said one or more services available from said plurality of service providers, said one or more broadcast areas having one or more areas of overlap; wherein said at least one consumer may receive delivery of broadcasts for said one or more services available from said one or more broadcast areas when at a location covered by said one or more broadcast areas.

19. The computer program product according to claim 18, wherein said third program instructions include instructions to determine whether said at least one consumer at said location within said broadcast area is interested in receiving delivery of broadcasts of said one or more services available at said location, and if said at least one consumer at said location is interested in receiving delivery of broadcasts of said one or more services available at said location, to configure said device for receiving delivery of said broadcasts of said one or more services available at said location within said broadcast area.

20. The computer program product according to claim 19, wherein said fourth program instructions include instructions to detect when a new service is available within a respective broadcast area and to retrieve data from said repository for broadcasting said new service to said plurality of consumers within said respective broadcast area.
